(19) United States
(12) Patent Application Publication
(10) Pub. No.: US 2004/0205808 A1
(43) Pub. Date: Oct. 14, 2004

(54) Sound effect CD cassette

(76) Inventor: Wei-Lii Horng, Taipei City (TW)

Correspondence Address: BACON & THOMAS, PLLC, 625 SLATERS LANE, FOURTH FLOOR, ALEXANDRIA, VA, 22314

(21) Appl. No.: 10/331,757

(22) Filed: Dec. 31, 2002

(51) Int. Cl. G11B 23/03

(52) U.S. Cl. 720/725

(57) ABSTRACT

The sound effect CD cassette for receiving a CD has a combination of a control circuit, a speaker and a battery; the control circuit is provided with a sound playing switch and a sound effect chip for recording. The sound effect recorded in the chip is a specification of the content of the CD or is a segment of the record from the content of the CD; so that a consumer or user can directly activate the playing switch on the CD cassette, the speaker on the CD cassette can thereby play the sound effect, the user can understand the specification of the content of the CD packed in the CD cassette from the sound effect.

### BACKGROUND OF THE INVENTION

1. Field of the Invention

The present invention is related to a sound effect CD cassette, and especially to a sound effect CD cassette with which a consumer or user can directly activate a playing switch on the CD cassette, so that a speaker on the CD cassette can play partial sound effect from the content of the CD or the specification of the content on the CD in order to quickly know the content of the CD packed in the CD cassette; thereby, the speed in selecting CDs' can be increased, and accuracy of selecting CDs' can also be increased.

2. Description of the Prior Art

Following popularization of the techniques of CD recording and large reducing of the cost of production, CDs' (including music CDs', video disks [VCD], digital versatile disks [DVD] and data video disks etc.) become the most popular and inexpensive storage media. No matter whether the content of a CD is in the form of simple data or is of a video and acoustic CD with sounds and images, generally, the CD needs a CD cassette for packing to suitably protect the CD, and the data recorded in the CD needs a specific device for accessing; thereby, the CD cassette is required to provide the function of protecting the CD as well as indicating the content of the CD.

However, a conventional CD cassette has the indicating function only for some pictures and some word specifications from those printed in the content of a CD, it is not only unable to really express the content of the CD, but also renders the users hard to read the heavy and complicated contents of the context; these make limitation on the designing of the cover papers of the CD cassette. Particularly when the CD packed in the CD cassette is a music CD, it even is unable to directly specify the features of the items in the song index of the music CD. And these results inconvenience in selection for purchasing or hearing the music CD by a consumer or user.

### SUMMARY OF THE INVENTION

The Synopsis of the Present Invention

The sound effect CD cassette of the present invention has a combination of a control circuit, a speaker and a battery in a CD cassette; the control circuit is provided with a sound playing switch and a sound effect chip for recording. The sound effect recorded in the chip is a specification of the content of the CD packed in the CD cassette, or is a segment of the record from the content of the CD; so that a consumer or user can directly activate the playing switch on the CD cassette, the speaker on the CD cassette can thereby play the sound effect, the user can understand the specification of the content of the CD packed in the CD cassette from the sound effect.

The Object and the Effects of the Present Invention

As stated above, the sound effect CD cassette of the present invention renders a consumer or user to be able to quickly know the content of the CD packed in the CD cassette by direct listening to the specification of the sound effect through the speaker on the CD cassette or by listening to a segment from the content of the CD; thereby, the speed of selecting CDs' can be increased.

The CD can make higher acceptance of consumers by the packing of the CD cassette having the sound effect, it can form an advertisement and propaganda effect to increase the willing of purchasing, and can increase the added value of the whole of the CD.

And more, the present invention can further make combination of a control circuit with a recording switch, so that a user can record the sound effect by himself from the content of the CD.

The present invention will be apparent in the structural combination and the mode of operation thereof after reading the detailed description of the preferred embodiment in reference to the accompanying drawings.

### BRIEF DESCRIPTION OF THE DRAWINGS

FIG. 1 is a perspective view showing the appearance of the sound effect CD cassette of the present invention;

FIG. 2 is a schematic view showing the structure from the front side of the present invention;

FIG. 3 is a circuit diagram of a control circuit of the present invention;

FIG. 4 is a perspective view showing the appearance of another embodiment of the sound effect CD cassette of the present invention;

FIG. 5 is a circuit diagram of a control circuit of another embodiment of the sound effect CD cassette of the present invention;

FIG. 6 is a perspective view showing the appearance of a further embodiment of the sound effect CD cassette of the present invention.

### DETAILED DESCRIPTION OF THE PREFERRED EMBODIMENT

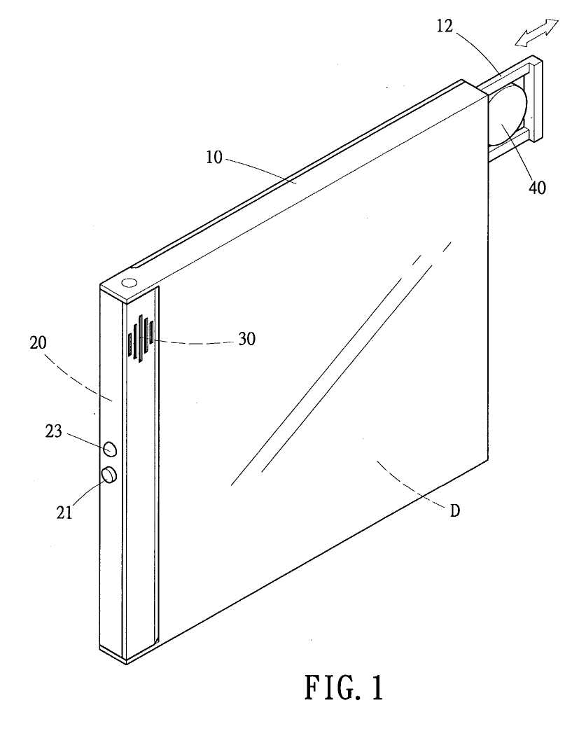

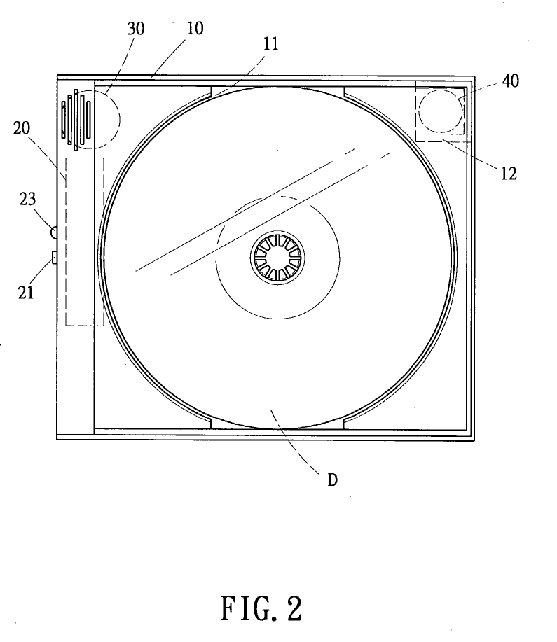

Referring firstly to FIGS. 1 and 2, in the structure of the sound effect CD cassette of the present invention, the main body of the CD cassette 10 has a receiving portion 11 for positioning a compact disk “D”, and has a control circuit 20 at a fixed position, at least a speaker 30 and at least a battery 40. Wherein the control circuit 20 is provided in a side space of the receiving portion 11, and it includes a sound playing switch 21 and an indicating lamp 23 both provided on an external surface of the CD cassette 10. The speaker 30 is similarly provided in a side space of the receiving portion 11 and is connected with the control circuit 20 to play a sound effect. Further, the CD cassette 10 is provided at a side space in the receiving portion 11 with a seat 12, the battery 40 can be mounted in the seat 12 and connected with the control circuit 20 to supply power for the control circuit 20; with the design of the seat 12, convenience of changing the battery 40 can be increased.

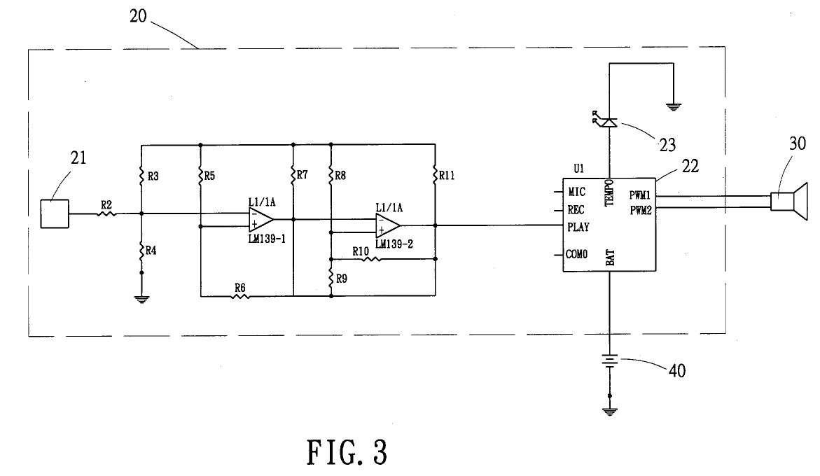

Referring simultaneously to FIGS. 2 and 3, wherein the control circuit 20 is provided with a chip 22 for recording sound effect in addition to being connected with the speaker 30 and the battery 40 and being provided with the sound playing switch 21 and the indicating lamp 23. The sound effect recorded in the chip 22 can be a specification of the content of the CD or is a segment of the record from the content of the CD; so that a consumer or user can directly activate the playing switch 21 on the CD cassette 10 without opening the CD cassette 10, the speaker 30 can thereby play the sound effect, the user can understand the specification of the content of the compact disk “D” packed in the CD cassette 10 from the sound effect played; and the speed of selecting CDs' can thereby be increased, the function of indicating and the added value of the CD cassette 10 can be increased.

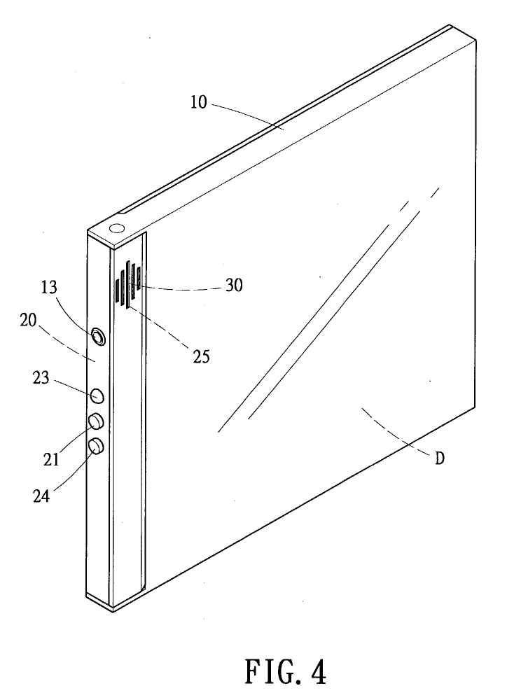

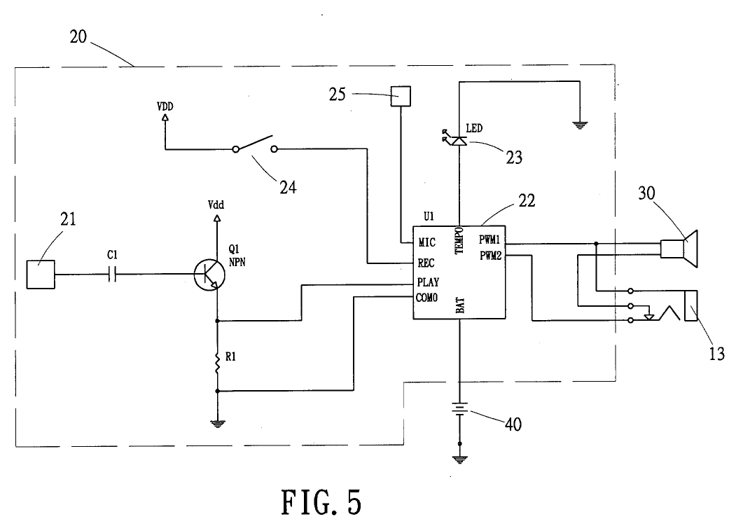

Certainly as shown in FIGS. 4 and 5, in addition to that the sound effect recorded in the chip 22 of the control circuit 20 can be the contents prerecorded by the manufacturer of the compact disk “D”, the control circuit 20 can further be connected with a recording switch 24 and a sound receiver element 25 of a microphone. The recording switch 24 can similarly be provided on an external surface of the CD cassette 10, and the sound receiver element 25 can be hidden in the CD cassette 10; so that a user can activate the recording switch 24 to render the sound receiver element 25 to do recording automatically for the contents of the compact disk “D”; and an earphone socket 13 can be provided on the CD cassette 10 to allow the user to hear the sound effect through an earphone, thereby, the scope of application of the CD cassette 10 can be increased.

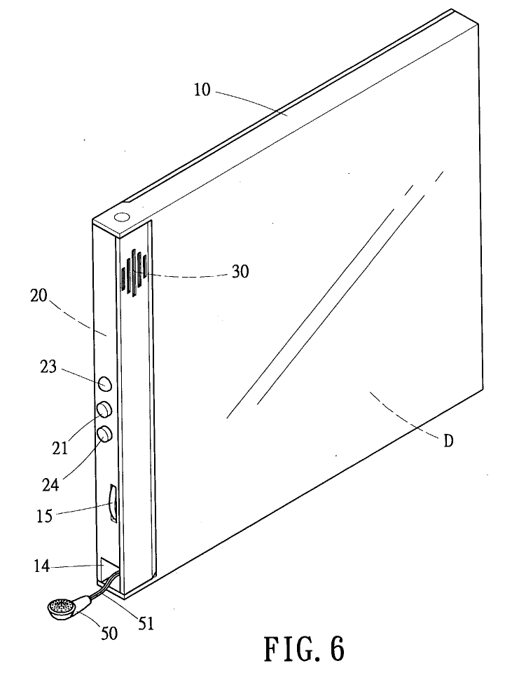

And more, as shown in FIG. 6, the CD cassette 10 can also be directly provided with an earphone 50; the earphone 50 is received in a recess 14 provided on the CD cassette 10 to connect with the control circuit 20 through an audio-source line 51. And a roller 15 is provided to reel in the audio-source line 51 of earphone 50; thereby, the user can pull the earphone 50 out of the recess 14 for hearing the sound effect, and the audio-source line 51 and the earphone 50 can be reeled in the recess 14 via the roller 15.

The sound effect CD cassette of the present invention comprises a combination of a control circuit with a speaker and a battery; the control circuit is provided with a playing switch and a chip for recording the specification of the content of the CD or a segmental sound effect of the record from the content of the CD. A consumer or user can directly activate the playing switch on the CD cassette, the speaker can thereby play the sound effect, the user can understand the specification of the content of the compact disk “D” from the sound effect played. Thereby, preferred embodiments as stated above of the structure of CD cassette can be obtained.

The preferred embodiments described and the shapes shown in the drawings are only for illustrating the present invention, and not for giving any limitation to the scope of the present invention. It will be apparent to those skilled in this art that various modifications or changes made to the elements of the present invention without departing from the spirit, scope and characteristic of this invention shall also fall within the scope of the appended claims.

1. A sound effect CD cassette, said CD cassette has in a main body thereof a receiving portion for positioning a compact disk, said CD cassette is characterized by that:
said main body of said CD cassette has therein a combination of a control circuit, at least a speaker and at least a battery; wherein said control circuit is provided with a sound playing switch and a chip for recording sound effect, said playing switch is directly activated to make said speaker play said sound effect, a user thereby understand the content of said compact disk packed in said CD cassette from said sound effect played.

2. The sound effect CD cassette as in claim 1, wherein
said control circuit is provided in a side space of said receiving portion; said sound playing switch is provided on an external surface of said CD cassette; and said speaker is provided in another side space of said receiving portion.

3. The sound effect CD cassette as in claim 1, wherein
said CD cassette is provided at a side space in said receiving portion with a seat, said battery is mounted in said seat.

4. The sound effect CD cassette as in claim 2, wherein
said CD cassette is provided at a side space in said receiving portion with a seat, said battery is mounted in said seat.

5. The sound effect CD cassette as in claim 2, wherein
said control circuit is connected with a recording switch and a sound receiver element.

6. The sound effect CD cassette as in claim 5, wherein
said recording switch is provided on an external surface of said CD cassette.

7. The sound effect CD cassette as in claim 5, wherein
said sound receiver element is hidden in a microphone provided in said CD cassette.

8. The sound effect CD cassette as in claim 1, wherein
said control circuit is provided on an external surface of said CD cassette with an indicating lamp.

9. The sound effect CD cassette as in claim 1, wherein
an earphone socket is provided on said CD cassette to connect with said control circuit.

10. The sound effect CD cassette as in claim 1, wherein
said CD cassette is provided with an earphone in connecting with said control circuit through an audio-source line.

11. The sound effect CD cassette as in claim 10, wherein
said CD cassette is provided with a recess to receive said earphone and said audio-source line, and a roller is provided to reel in said audio-source line of said earphone.
